(19) United States
(12) Patent Application Publication
(10) Pub. No.: US 2019/0255659 A1
(43) Pub. Date: Aug. 22, 2019

(54) MATERIAL MIXTURE, METHOD FOR PROTECTING A COMPONENT, METHOD FOR LASER DRILLING, AND COMPONENT

(71) Applicant: Siemens Aktiengesellshaft, München (DE)

(72) Inventors: CHRISTOPHER DEGEL, BERLIN (DE); DIANA FELKEL, BERLIN (DE); ANDREA MASSA, BERLIN (DE)

(21) Appl. No.: 16/333,660

(22) PCT Filed: Aug. 22, 2017
(86) PCT No.: PCT/EP2017/071110

§ 371 Date: Mar. 15, 2019

(30) Foreign Application Priority Data
Sep. 21, 2016 (EP) 16189862.2

(51) Int. Cl. B23K 26/382; B23K 26/18; B23K 26/40

(52) U.S. Cl. CPC B23K 26/382; B23K 26/18; B23K 2101/001; B23K 26/40; B23K 26/389

(57) ABSTRACT

By using a water-based liquid mixture containing amino acids, the cavities of a hollow component can be filled very easily and very quickly, while nevertheless providing the internal structure with adequate protection. In addition, the filling material can be removed again very easily after the laser drilling.

### CROSS-REFERENCE TO RELATED APPLICATIONS

This application claims priority to PCT Application No. PCT/EP2017/071110, having a filing date of Aug. 22, 2017, which is based on European Application No. 16189862.2, having a filing date of Sep. 21, 2016, the entire contents both of which are hereby incorporated by reference.

### FIELD OF TECHNOLOGY

The following relates to a method of laser drilling, to a corresponding protection method and to a component, in which a filling material is introduced into the hollow component.

### BACKGROUND

High-temperature components such as turbine blades are cooled in their interior, with additional passage of air or hot steam through film cooling holes to additionally protect the surface.

Therefore, it is necessary to introduce through-holes into the hollow-cast component. However, the internal structures, on drilling, must not be so significantly damaged, if at all, when the laser beam passes into the interior of the hollow cavity on breakthrough.

It is often the case that a material that is hard at room temperature is fluidized and introduced into the cavity under pressure. Then the laser beam is applied, and then the material has to be removed again by a laborious and long burnout process.

### SUMMARY

An aspect relates to a material mixture, especially for protection in a laser processing operation, which is especially pulverulent, at least comprising: at least one, especially more than one, amino acid, at least one, especially more than one, lipid, at least one, especially more than one, polysaccharide, especially heteropolysaccharides, optionally: at least one, especially more than one, salt, especially pyruvate, and at least one, especially more than one, sulfate.

### BRIEF DESCRIPTION

Some of the embodiments will be described in detail, with reference to the following figures, wherein like designations denote like members, wherein:

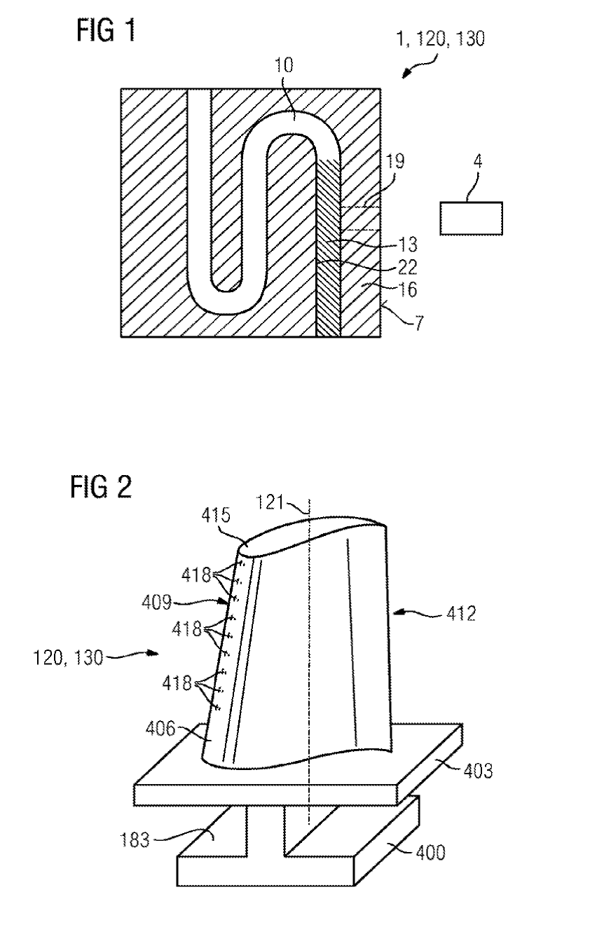

FIG. 1 a schematic of a laser drilling device with a component;

FIG. 2 a turbine blade; AND

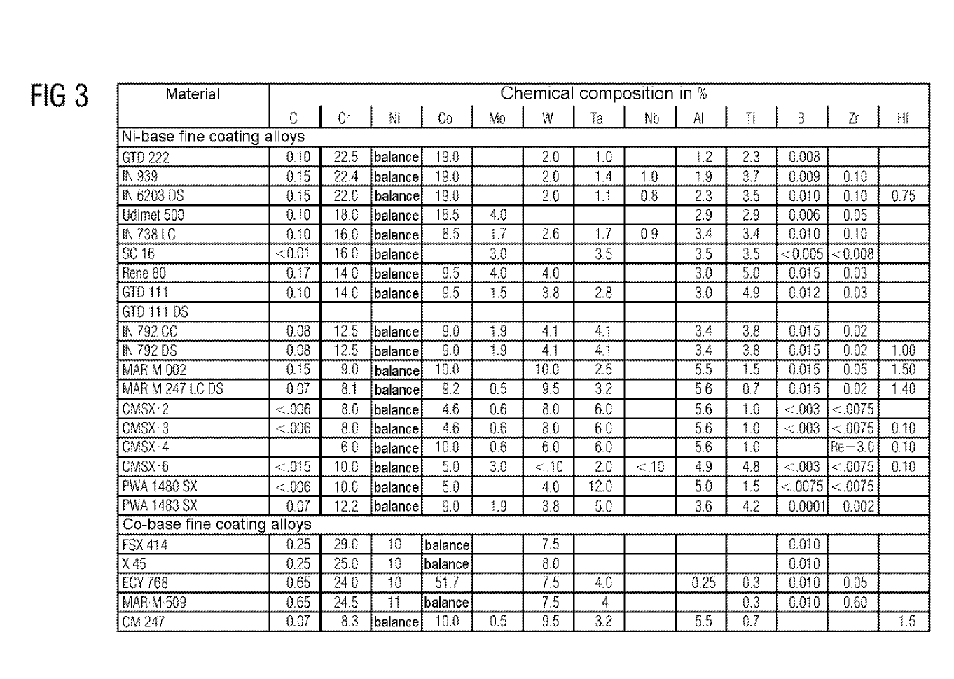

FIG. 3 a list of superalloys.

The figures and the description are merely working examples of embodiments of the invention.

### DETAILED DESCRIPTION

FIG. 1 shows, merely as an illustrative hollow component 1, a detail of a turbine blade 120, 130 (FIG. 2) made of a nickel- or cobalt-based alloy, according to FIG. 3, having a cavity 10.

A through-hole 19 (illustrated merely by way of example hereinafter)—indicated by dotted lines—is to be produced in the region 19 through a wall 16 of the cavity 10 of the component 1, 120, 130.

This is effected by means of a laser 4 (or electron gun), the beams of which remove material from the wall 16 proceeding from the surface 7. On breakthrough into the cavity 10 of the hollow component 1, 120, 130, the internal structure 22 in the cavity 10 could be damaged.

To prevent this, a material mixture 13 is introduced into the cavity 10 at least in the region of the through-hole 19 to be made.

The material mixture 13 is pulverulent and includes at least:

at least one, especially more than one, amino acid,
at least one, especially more than one, lipid,
at least one, especially more than one, polysaccharide, especially heteropolysaccharides, optionally:
at least one, especially more than one, salt, especially pyruvate, and
at least one, especially more than one, sulfate.

The material mixture 13 is prepared as a slip, with water, and then heated prior to processing in the component 1, 120, 130, at 373 K to 383 K, especially for 10 min to 120 min, very particularly for 90 min, such that the slip solidifies.

The at least one amino acid includes at least (C₁₂H₁₈O₉)ₓ (x is a natural number).

The at least one saccharide includes C₃H₆O₃, C₁₂H₂₂O₁₁ and/or C₆H₁₂O₆.

The at least one lipid especially includes C₄₋₁₈H₈₋₃₆O₂, especially 13 triglycerides (4-18 and 8-36 indicates a range).

This results in better processing of the slip.

After the processing, especially the laser drilling, the material mixture 13 can simply be removed from the blade 120, 130, especially by clearance by washing or boiling.

The material mixture 13 acts as protection, and so it is possible to employ either the percussion method or the trepanning method in order to produce a high-quality hole 19 and to avoid a recast.

After the holes 19 have been made, the material mixture 13 can simply be removed. This can be assisted by shaking and/or agitation.

In this way, even meandering cavities 10 are readily accessible.

One application case also involves the reopening of holes in a component 1, 120, 130 when the component 1, 120, 130 with already drilled through-holes is being coated and the cavity 10 is likewise being protected.

The embodiments described achieves distinct savings in laser drilling process time and in process preparation and reprocessing. Moreover, there is a rise in the quality of the holes since it is possible to use both percussion methods and trepanning methods.

The advantage here is that the interior can be completely filled as a result of filling with the material mixture and hence better protected.

FIG. 2 shows, in a perspective view, a rotor blade 120 or guide vane 130 of a turbo machine that extends along a longitudinal axis 121.

The turbo machine may be a gas turbine of an aircraft or of a power plant for electricity generation, a steam turbine or a compressor.

The blades/vanes 120, 130 have, successively along the longitudinal axis 121, a securing region 400, an adjoining blade/vane platform 403, and a main blade/vane 406 and a blade/vane tip 415.

As guide vane 130, the vane 130 may have a further platform at its vane tip 415 (not shown).

In the securing region 400 is formed a blade/vane root 183 which serves to secure the rotor blades 120, 130 to a shaft or disk (not shown).

The blade/vane root 183 is configured, for example, as a hammerhead. Other configurations as a firtree or dovetail root are possible.

The blades/vanes 120, 130 have a leading edge 409 and a trailing edge 412 for a medium that flows past the turbine blades 406.

In the case of conventional blades/vanes 120, 130, in all regions 400, 403, 406 of the blades/vanes 120, 130, for example, solid metallic materials, especially superalloys, are used. Superalloys of this kind are known, for example, from EP 1 204 776 B1, EP 1 306 454, EP 1 319 729 A1, WO 99/67435 or WO 00/44949.

The blades/vanes 120, 130 may have been manufactured here by a casting method, including by means of directional solidification, by a forging method, by a machining method or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, it is necessary to avoid the transition to globular (polycrystalline) solidification, since non-directional growth inevitably forms transverse and longitudinal grain boundaries, which negate the favorable properties of the directionally solidified or single-crystal component.

Where the text refers in general terms to directionally solidified microstructures, this means both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades/vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is 95% of the theoretical density.

A protective aluminum oxide layer (TGO=thermally grown oxide layer) is formed on the MCrAlX layer (as an intermediate layer or as the outermost layer).

The layer has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, to improve the resistance to thermal shocks. The thermal barrier coating is therefore more porous than the MCrAlX layer.

Refurbishment means that, after they have been used, protective layers may have to be removed from components 120, 130 (e.g. by sand-blasting). Then the corrosion and/or oxidation layers and products are removed. If appropriate, cracks in the component 120, 130 are also repaired. This is followed by recoating of the component 120, 130, after which the component 120, 130 can be reused.

The blade/vane 120, 130 may be hollow or solid in form. If the blade/vane 120, 130 is to be cooled, it is hollow and may also have film cooling holes 418 (indicated by dotted lines).

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A material mixture for protection in a laser processing operation,
which is especially pulverulent, the material mixture comprising:
at least one amino acid;
at least one lipid;
at least one polysaccharide, especially heteropolysaccharides; and
at least one salt, especially pyruvate, and
at least one sulfate.

2. The material mixture as claimed in claim 1, in which the at least one amino acid includes at least (C₁₂H₁₈O₉)ₓ.

3. The material mixture as claimed in claim 1, in which the at least one saccharide includes C₃H₆O₃, C₁₂H₂₂O₁₁ and/or C₆H₁₂O₆.

4. The material mixture as claimed in claim 1, in which the at least one lipid includes C₄₋₁₈H₈₋₃₆O₂, especially 13 triglycerides.

5. A slip, including a liquid and the material mixture as claimed in claim 1.

6. A method of protecting a component when working with an energy beam,
in laser drilling, wherein the component has a cavity, wherein a through-hole is introduced through a wall of the cavity of the component, the method comprising:
filling the cavity at least in a region of a region to be processed, with the material mixture as claimed in claim 1 or a slip.

7. The method as claimed in claim 6, in which the entire cavity is filled with the material mixture.

8. The method as claimed in claim 6, in which the material mixture is heated prior to the processing at 373 K to 383 K for 10 min to 120 min.

9. A method of laser drilling a component, in which a through-hole is introduced through a wall of the cavity of the component, and a method of protecting the cavity as claimed in claim 6 is used.

10. The method as claimed in claim 9, in which the component is cleared by washing or boiling to remove the material from the cavity.

11. A hollow cavity with a material mixture as claimed in claim 1 or a slip in the cavity.
